(19) United States
(12) Patent Application Publication
(10) Pub. No.: US 2010/0111658 A1
(43) Pub. Date: May 6, 2010

(54) Apparatus for Transporting Game with an All Terrain Vehicle

(76) Inventors: Travis Galliano, Weir, MS (US); Ricky Black, McCool, MS (US)

Correspondence Address: FRASCOGNA COURTNEY, PLLC, P.O.BOX 23126, JACKSON, MS, 39225-3126, US

(21) Appl. No.: 12/264,504

(22) Filed: Nov. 4, 2008

(51) Int. Cl. B66C 23/44

(52) U.S. Cl. 414/462; 414/815

(57) ABSTRACT

An apparatus for transporting game with an all terrain vehicle is disclosed. The apparatus may be attached to the hitch of an ATV with an optional secondary attachment for an ATV rack. The apparatus uses a combined lifting and pivoting motion to raise the game from the ground and secure the game to the body of the ATV. This motion secures the game for transport and minimizes alterations to the ATVs center of mass, minimizing ATV tipping hazards when carrying heavy loads.

### FIELD OF THE INVENTION

This invention relates generally to all terrain vehicle attachments and specifically to all terrain vehicle attachments that secure game during transport.

### BACKGROUND OF THE INVENTION

Hunters often travel to remote areas in search of wild game. These areas are typically inaccessible to automobile traffic and are often several miles from the nearest parking location. Many hunters employ all terrain vehicles also known as ATVs in order to transport themselves and their gear from their automobile to the hunting site.

When a hunter makes a kill, he is faced with the problem of transporting the game back to his automobile. Hunters using ATVs may attempt to transport the game by using a rope or similar item to tie the animal to some portion of the ATV. This solution is time consuming and may not be secure if the hunter is not adept at knot tying. If the rope becomes unsecured during transport, the animal may fall from the ATV, potentially causing injury to the hunter and damage to the ATV and the animal. This method also has the disadvantage of allowing any blood or dirt present on the animal to be spread on the ATV. Finally, this method may be impossible when dealing with larger animals. Animals such as elk, deer, or wild boar are often too heavy for an individual hunter to lift onto the ATV.

Many ATV attachments have been created to lift game or similar cargo onto an ATV. Some ATV lifts attach primarily to an ATV rack. This is disadvantageous for larger cargo because most ATV racks are not designed to support heavy loads and will often break if placed under heavy strain for an extended period. Some ATV lifts require mechanical force to lift the game, which is disadvantageous for heavy game, especially when the hunter is tired or has a reduced ability to lift heavy objects due to medical conditions or the like. Other ATV lifts raise the game into the air for purposes of field dressing, but do not secure the game well for transport. Additionally, lifting heavy game in the vertical direction only raises the center of mass of the ATV, which may reduce the stability of the vehicle during transport.

Therefore, what is needed is an apparatus for transporting game with an all terrain vehicle. The apparatus should attach primarily to the ATV hitch for greater durability and be capable of lifting heavy loads without requiring significant user strength, securing the game for transport, and keeping the game close to the body of the ATV to maintain stability during transport. Furthermore, other desirable features and characteristics of the present invention will become apparent when this background of the invention is read in conjunction with the subsequent detailed description of the invention, appended claims, and the accompanying drawings.

### SUMMARY OF THE INVENTION

The present invention advantageously fills the aforementioned deficiencies by providing an apparatus for transporting game with an all terrain vehicle. The apparatus is durable, lifts heavy objects, is easy to load, and does not reduce the stability of the ATV. The apparatus easily attaches to the hitch of an ATV and in some embodiments also attaches to the ATV rack for added support. The apparatus is capable of being lowered to the ground to allow the hunter to load the game without requiring the hunter to lift the animal's weight. The apparatus is also capable of both raising and pivoting the game for maximum stability and safety during transport. The apparatus may also be secured for transit when not in use.

The present invention now will be described more fully hereinafter with reference to the accompanying drawings, which are intended to be read in conjunction with both this summary, the detailed description, and any preferred and/or particular embodiments specifically discussed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The drawings contained herein exemplify one of the embodiments of the claimed invention. The invention is not limited to the embodiment shown. The embodiment shown is purely an example, and the invention is capable of many variations of said embodiment. In the drawings,

FIG. 1 illustrates a perspective view of the present invention in the horizontal position.

FIG. 2 illustrates a perspective view of the present invention in the locked position.

FIG. 3 illustrates a perspective view of the present invention in the loading position.

FIG. 4 illustrates a perspective view of the present invention in the raised position.

The first digit of each reference numeral in the above figures indicates the figure in which an element or feature is most prominently shown. The second digit indicates related elements or features, and a final letter (when used) indicates a sub-portion of an element or feature.

### DETAILED DESCRIPTION OF THE INVENTION

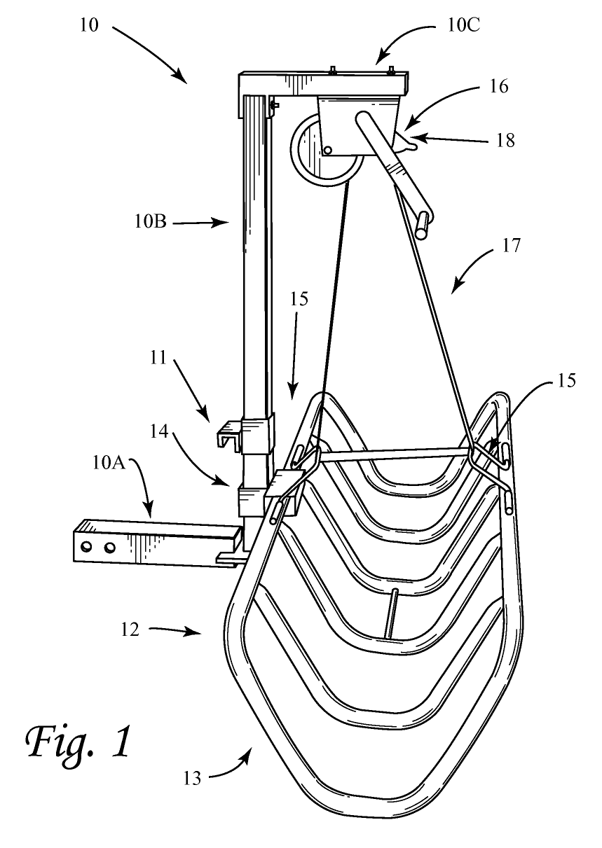

FIG. 1 illustrates a perspective view of the present invention in the horizontal position. The horizontal position is primarily used to retain game or other cargo during transit. FIG. 1 discloses, among other components, the structure member 10. The structure member 10 further comprises the primary attachment portion 10A. The primary attachment portion should be capable of being releaseably attached to the hitch of an ATV. In the preferred embodiment, the primary attachment portion 10A should comprise a rectangular prism shape that may be inserted and bolted into a standard ATV receiver hitch assembly. However, in other embodiments the primary attachment portion 10A may comprise any shape that may be attached and removed from any ATV hitch or hitch assembly. Once the user releasably attaches the primary attachment portion 10A of the structure member 10 to the ATV hitch, the weight of the apparatus and any cargo carried is supported by the ATV hitch.

The structure member 10 further comprises a plurality of glide portions 10B which are connected to the primary attachment portion 10A. The purpose of the glide portions 10B is to slidably receive other components. This allows the other components to move vertically, while remaining in contact with the glide portions 10B. In the preferred embodiment, only one glide portion is employed, but more glide portions 10B may be added to allow more components to be slidably received. While more than one glide portion may be present, the glide portions 10B will be referenced as singular hereinafter.

In the preferred embodiment, the structure member 10 also comprises a secondary attachment portion 11. The secondary attachment portion 11 is slideably received by the glide portion 10B. This configuration allows the secondary attachment portion 11 to be vertically adjustable to accommodate different ATVs. The secondary attachment portion 11 should also be capable of being releasably attached to the rack of an ATV. The secondary attachment portion 11, when attached to the ATV rack, allows the apparatus to have more attachment points with the ATV to help distribute any apparatus load to maintain stability. In the preferred embodiment, the majority of the load stress remains on the ATV hitch to reduce the possibility of ATV rack breakage when heavy loads are transported. In the preferred embodiment, the user should attach the secondary attachment portion 11 to the ATV rack prior to placing cargo in the apparatus and after attaching the primary attachment portion 10A to the ATV hitch. In alternate embodiments, the secondary attachment portion 11 may be omitted, in which case all of the apparatus load stress would be placed on the ATV hitch by the primary attachment portion 10A.

The structure member 10 further comprises a suspension portion 10C connected to the glide portion 10B. The purpose of the suspension portion 10C is to serve as a support for other components of the device as discussed more fully below.

The apparatus also comprises a game retaining member 12, which further comprises a basket member 13 and a slide collar member 14. In the preferred embodiment, the basket member 13 is shaped to receive most large game; however, other shapes may be employed to better receive specific types of game, or smaller game. The slide collar member 14 is connected to the basket member and slidably received by the glide portion 10B of the structure member 10. The slide collar member 14 should be connected to the basket member 13 in a way that allows the basket member 13 to pivot relative to the ground while the slide collar member 14 remains slidably received by the glide portion 10B. In the preferred embodiment, the slide collar member 14 further comprises a hollow box shape that receives the basket member 13. However, the slide collar member 14 may be configured in any manner that would allow the basket member 13 to pivot. The slide collar member 14 should also be capable of moving vertically relative to the glide portion 10B. This configuration allows the game retaining member 12 to pivot and be raised and lowered along the glide portion 10B of the structure member 10, allowing for a range of different motions.

In the preferred embodiment, the game retaining member 12 further comprises two or more bracket members 15 connected to the basket member 13. In an alternate embodiment, some of the bracket members 15 may instead be attached to the slide collar member 14. The bracket members 15 each function as an attachment point for other components of the device as discussed below. In the preferred embodiment, each bracket member 15 should be capable of making partial rotations around a horizontal axis. This allows the bracket members 15 to pivot for better attachment to other components while remaining connected to the basket member 13 or slide collar member 14 respectively.

The apparatus also comprises an elevation member 16. The elevation member 16 should be connected to the suspension portion 10C of the structure member 10. The connection to the suspension portion 10C ensures the elevation member 16 remains suspended over the basket member 13 of the game retaining member 12.

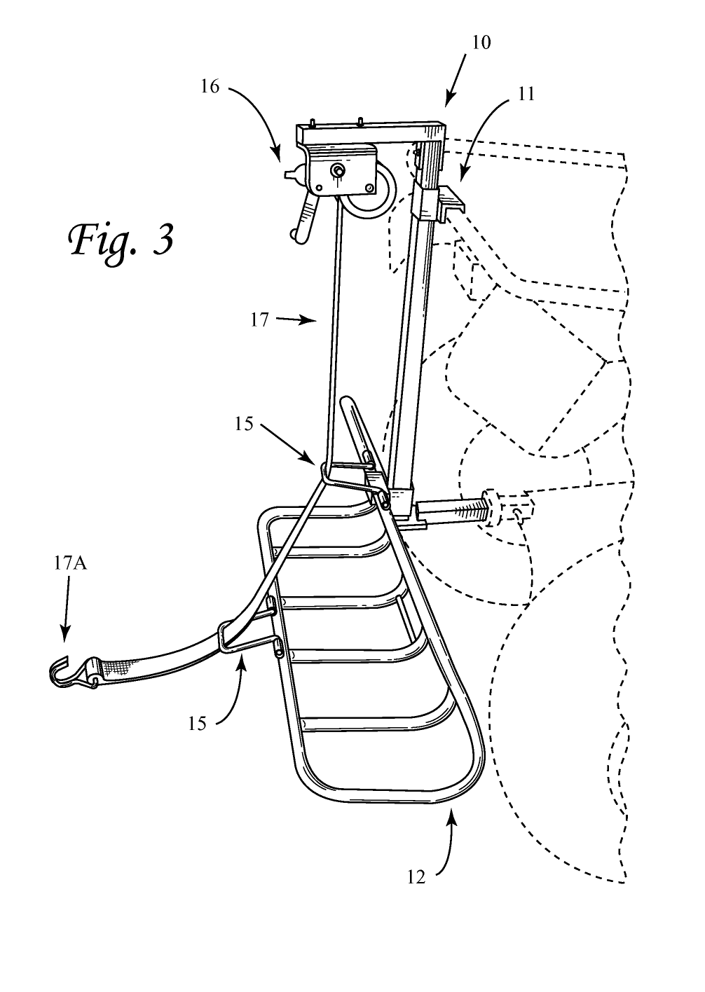

The elevation member further comprises a belt member 17 which is capable of being releasably attached to the game retaining member 12. While the belt member 17 may be releasably attached to the game retaining member 12 in many ways, in the preferred embodiment, the belt member 17 is releasably attached to the bracket members 15 of the game retaining member 12. The belt member 17 is attached by placing the belt through each bracket member 15. Briefly referencing FIG. 3 the belt member 17 also comprises an attachment potion 17A, which is discussed more fully below.

The elevation member 16 further comprises a hoist member 18. The hoist member 18 is connected to the belt member 17 and the suspension portion 10C. The hoist member 18 can be any device capable of raising and lowering the game retaining member 12 when the belt member 17 is attached to the game retaining member 12. In the preferred embodiment, the hoist member 18 is a crank which uses the belt member 17 to raise and lower the game retaining member 12. In the preferred embodiment, the belt member 17 remains connected to the hoist member 18 at all times. Meanwhile, an attachment portion of the belt member 17A is releasably attached to the game retaining member 12 and connected back to the hoist member 18. In this configuration, the hoist member 18 uses a cranking action to lengthen or shorten the amount of the belt member 17 suspended between the two hoist connection points. Changing the length of the suspended portion of the belt member 17 causes the game retaining member 12 to raise and lower accordingly. In alternate embodiments, the hoist member 18 may be selected to be an electrically powered crank or a less expensive manually operated hand crank or any similar device depending on the desired manufacturing costs.

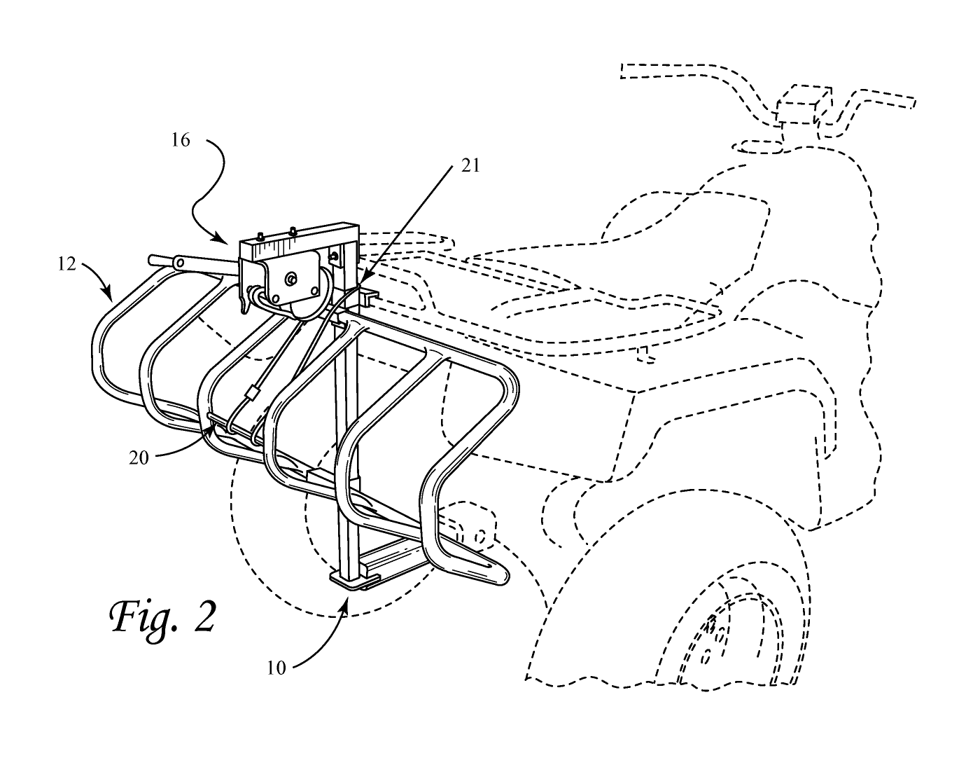

FIG. 2 illustrates a perspective view of the present invention in the locked position. In FIG. 2, the game retaining member 12 further comprises a plurality of fastening members 20 connected to the basket member 13. In the preferred embodiment, the fastening member 20 is a single bar.

In FIG. 2, the structure member 10 further comprises a plurality of locking members 21 received by the glide portions 10B of the structure member 10. In the preferred embodiment, the locking members 21 are a pair of hooks attached by a length of cord. The locking members 21 may be received by the glide portion of the structure member 10. In the preferred embodiment, the locking members 21 are placed over the secondary attachment portion 11, and releasably attached to the fastening members 20 of the game retaining member 12. In the preferred embodiment, the locking members 21 may be removed from the device when not in use. While the preferred embodiment comprises a pair of hooks and a single bar, the fastening members 21 and the locking members 21 may be any equivalent device or devices that can hold the game retaining member 12 in the locked position.

The apparatus may be placed in the locked position by raising the game retaining member 12 from the horizontal position. The game retaining member 12 may then be rotated into the locked position using the pivoting motion allowed by the slide collar member 14 connection to the basket member 13. For the apparatus to remain in the locked position, the locking members 21 of the structure member 10 should be releasably attached to the fastening members 20 of the game retaining member 12.

FIG. 3 illustrates a perspective view of the present invention in the loading position. The loading position is employed when the user wishes to load game or other cargo into the apparatus. To move the apparatus from the horizontal position to the loading position, the user manipulates the elevation member 16 to lower the game retaining member 12 as described above. When the slide collar member 14 reaches the bottom of the glide portion 10B of the structure member 10, the game retaining member 12 pivots as discussed above, allowing the basket member 13 to touch the ground behind the ATV.

Once the apparatus is in the loading position, the user may release the attachment portion of the belt member 17A from the hoist member 18. The attachment portion of the belt member 17A may then be removed from the bracket members 15. The game or other cargo may then be placed in the game retaining member 12 without requiring any lifting on the part of the user. The attachment portion of the belt member 17A may then be placed through the bracket members 15 and attached to the hoist member 18 to secure the game. The user may then manipulate the elevation member 16 to raise the game retaining member 12 into the horizontal position as shown in FIG. 1 or the raised position as discussed below.

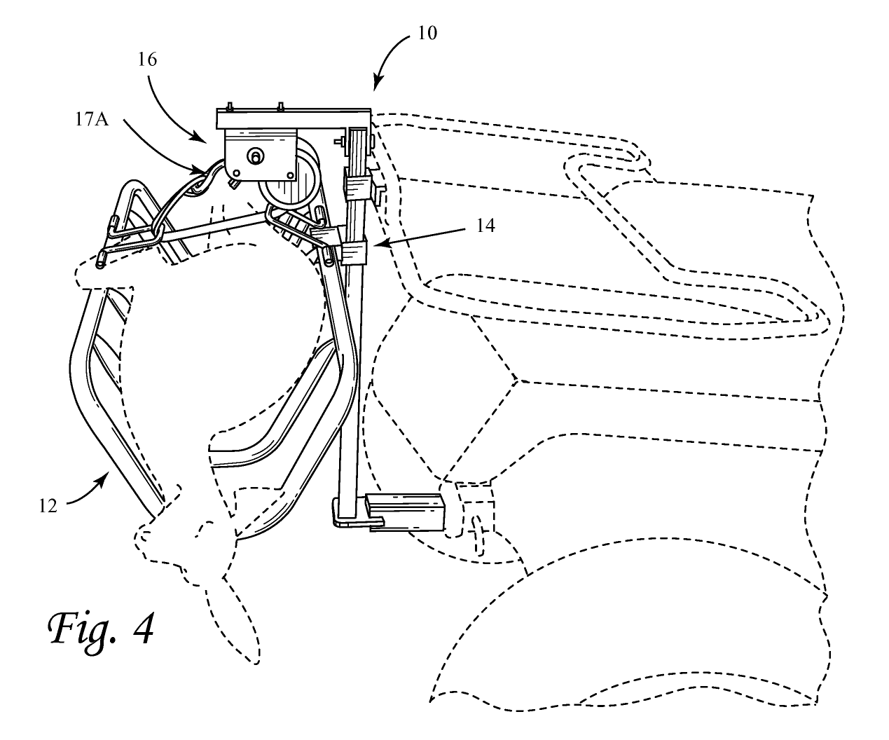

FIG. 4 illustrates a perspective view of the present invention in the raised position. In the raised position, the game retaining member 12 has been raised above the horizontal position to bring the cargo further from the ground. The user may wish to use the raised position if the cargo extends beyond the sides of the game retaining member 12 and hangs down. This would prevent the cargo from dragging on the ground during transit. In the preferred embodiment, the user may adjust the height of the game retaining member 12 to any point between the horizontal position and the raised position prior to transit depending on the users needs with respect to a particular load.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. An apparatus for transporting game with an all terrain vehicle comprising:
a structure member further comprising a primary attachment portion capable of being releasably attached to a hitch of an all terrain vehicle, a plurality of glide portions connected to the primary attachment portion, and a suspension portion connected to the glide portions;
a game retaining member further comprising a basket member for receiving cargo and a slide collar member connected to the basket member and slideably received by the glide portions of the structure member, for allowing the basket member to move vertically relative to the glide portions of the structure member, and for allowing the basket member to pivot relative to the ground; and
an elevation member connected to the suspension portion of the structure member, further comprising, a belt member capable of being releasably attached to the game retaining member, and a hoist member connected to the belt member and capable of raising and lowering the game retaining member when the belt member is attached to the game retaining member.

2. The apparatus of claim 1, wherein the structure member further comprises a secondary attachment portion slideably received by the glide portions, which is capable of being releasably attached to a rack of an all terrain vehicle.

3. The apparatus of claim 1, wherein the hoist member of the elevation member is manually operated.

4. The game transporting apparatus of claim 1, wherein the hoist member of the elevation member is electrically powered.

5. The apparatus of claim 1, wherein the game retaining member further comprises a plurality of bracket members connected to the basket member.

6. The apparatus of claim 1, wherein the game retaining member further comprises a plurality of bracket members connected to the slide collar member.

7. The apparatus of claim 5, wherein the belt member of the elevation member is capable of being releasably attached to the bracket members of the game retaining member.

8. The apparatus of claim 5, wherein each bracket member of the game retaining member is capable making partial rotations around a horizontal axis.

9. The apparatus of claim 1, wherein the game retaining member further comprises a plurality of fastening members connected to the basket member.

10. The apparatus of claim 9, wherein the structure member further comprises a plurality of locking members received by the glide portions of the structure member.

11. The apparatus of claim 10, wherein the locking members are capable of being releasably attached to the fastening members of the game retaining member.

12. A method of transporting game with an apparatus for transporting game, said method comprising:
manipulating the elevation member of the apparatus to lower the game retaining member of the apparatus to the loading position;
releasing the attachment portion of the belt member of the elevation member from the hoist member of the elevation member;
placing cargo in the game retaining member;
releasably attaching the attachment portion of the belt member of the elevation member to the hoist member of the elevation member; and
manipulating the elevation member to raise the game retaining member to the horizontal position.

13. The method of claim 12, further comprising releasably attaching the primary attachment portion of the structure member of the game transporting apparatus to a hitch of an all terrain vehicle.

14. The method of claim 13, further comprising releasably attaching the secondary attachment portion of the structure member of the game transporting apparatus to a rack of an all terrain vehicle.

15. The method of claim 12, further comprising rotating the game retaining member into the locked position.

16. The method of claim 15, further comprising releasably attaching the locking members of the structure member to the fastening members of the game retaining member.

17. The method of claim 12, further comprising removing the attachment portion of the belt member of the elevation member from the bracket members of the game retaining member.

18. The method of claim 12, further comprising placing the attachment portion of the belt member of the elevation member through the bracket members of the game retaining member prior to attaching said attachment portion of the belt member to the hoist member of the elevation member.

19. The method of claim 12, further comprising manipulating the elevation member of the apparatus to raise the game retaining member of the apparatus into the raised position.
